(19) United States
(12) Patent Application Publication
(10) Pub. No.: US 2021/0068411 A1
(43) Pub. Date: Mar. 11, 2021

(54) ANTIOXIDATIVE METHOD FOR COLD DEHYDRATION AND PACKAGING OF FRUIT AND VEGETABLE PRODUCTS, COOKING OVEN AND PRODUCT THUS OBTAINED

(71) Applicants: Enrico Alexander Fernando FEULNER, Aprilia (LT) (IT); Federico Maximilian Sebastian FEULNER, Aprilia (LT) (IT)

(72) Inventors: Enrico Alexander Fernando FEULNER, Aprilia (LT) (IT); Federico Maximilian Sebastian FEULNER, Aprilia (LT) (IT)

(21) Appl. No.: 17/049,675

(22) PCT Filed: Apr. 8, 2019
(86) PCT No.: PCT/IB2019/052873

§ 371 Date: Oct. 22, 2020

(30) Foreign Application Priority Data
Apr. 24, 2018 (IT) 102018000004819

(51) Int. Cl. A23B 7/02; A23B 7/005

(52) U.S. Cl. CPC A23B 7/02; A23B 7/005

(57) ABSTRACT

Disclosed is an antioxidative method for cold dehydration and packaging of fruit and vegetable products, including: reception and verification of their biological certification; manual or automatic washing with drinking water; manual or automatic peeling; cutting, by hand or by special automatic machines; cooking in the oven with dehumidifier and gas burner, at a temperature between 25° C. and 40° C., for 24/48 hours; during cooking, the dehumidified air is discharged from the first end and suctioned wet by the second end and vice versa with alternating steps of 15 minutes; packing, immediately after the dehydration, by way of common machines suitable for packaging a predetermined amount of fruit and vegetable products in sealed opaque bags filled with nitrogen for food use; and storage in dark, fresh and dry warehouses.

### FIELD OF THE INVENTION

The present invention relates to an industrial system of cold dehydration of fruit and vegetables and, more generally, of all those foods suitable for drying through a new and innovative process that keeps the organoleptic and nutritive properties intact, and limits the process of oxidation as much as possible.

### PRIOR ART

In industry jargon, the word “drying” is used when proceeding with natural means, exploiting the action of the rays of the sun to dehydrate a food (or any natural product: see medicinal herbs, tobacco . . . ) and extract the water present. On the other hand, when the process is artificial, as in the industrial sector, it is called “dehydration”.

Dehydration is a reaction resulting from a process that leads to the elimination of a molecule of water from the reactant molecule.

Dehydration eliminates the water present in food, so as to prevent deterioration due to fermentation by microbes (bacteria, molds, yeasts) or by enzymes activity. In this way, one can keep food for a long time without having to add preservatives and keeping the organoleptic and nutritional qualities intact.

In dehydration, hot air is used to eliminate water, after having scalded food in boiling water. This technology reproduces the ancient sun-drying process of foods.

Industrial dehydration developed at the beginning of the 20th century, by heating the food using hot air, gas, contact with hot surfaces or infrared radiation. Depending on the percentage of water present, the food is subjected to different temperatures: between 30° C. and 40° C. it is called a low temperature; between 50° C. and 60° C. medium temperature, while between 70° C. and 90° C. it is high temperature drying.

Among the various dehydration techniques in use, in the prior art, we may mention that of vacuum dehydration, which provides a pre-drying, at medium-high temperatures, to bring the product to a residual humidity of about 20%-30%. Subsequently, by means of the vacuum, the boiling/evaporation point of the water is lowered and it can thus be extracted at medium-low temperatures.

Another widely used technique is that of freeze-drying. Freeze-drying is a technological process that allows the total elimination of water from food, which is reduced to dehydrated powders. It is treated at temperatures ranging from −30° C. to −50° C., sold on the market as cold dehydrated products and used in raw food.

Freeze-drying, in addition to the high industrial cost, also exhibits other drawbacks, including, primarily, the alteration of the organoleptic and nutritive properties that, due to the aggressive treatment to which foods are subjected, are lost producing a change not only in consistency but also taste.

A first object of the present invention is therefore that of leaving the nutritional properties and the molecular structure of the macro- and micro-nutrients of foods unaltered, generating a healthy and genuine final product. To do this it is necessary to eliminate from the industrial process all sources of oxidation of food, in the first place oxygen.

The method described below, therefore, aims to make this innovation within the agricultural-food sector, providing a completely natural, healthy, organic/biodynamic product that maintains all the qualities, even nutritious ones, typical of fresh products.

### DESCRIPTION OF THE INVENTION

According to the present invention, a dehydration method for fruit and vegetable products is described, including final packaging and oven, which effectively solves the above-mentioned problems.

The method, as we will see later, includes numerous advantages. Firstly, the substantial preservation of the nutritive and organoleptic properties of the products thus treated.

Secondly, foods are preserved for a long time because, from the moment they enter the dehydration and packaging laboratory, they come into the lowest possible contact with oxygen, heat, light and metals, all the main oxidation and deterioration factors.

This method, which is also useful for the biological and biodynamic certification of the whole product processing, advantageously consists of the following steps:
reception of fruit and vegetables in the laboratory and verification of their organic/biodynamic certification. In the event of a negative outcome of the verification, the method provides for the rejection of said products. In the event of a positive outcome of said verification, the method proceeding with a step of
manual or automatic washing, by means of special machines, using filtered potable water;
manual or automatic peeling, by means of special machines, depending on the dimensions of the fruit and vegetable products being processed;
cutting, manually or by means of special automated machines, into pre-established shapes such as cubes or slices, depending on the type of fruit and vegetable products being processed. The shape and size of the cut product depends on its resistance and dehydration capacity. This method, in fact, also aims to avoid that the consumer finds food portions already broken in the package. Advantageously, in the preferred embodiment, the cutting takes place by means of ceramic or ceramic-coated blades, again to avoid possible oxidation of the food;
a possible recycling step of the waste parts of fruit and vegetables for reuse in other production processes, such as, for example, the production of dehydrated fruit bases for snack bars;
positioning of the cut portions on special grids or on a conveyor belt, according to the type of oven that will be used in the following step. More specifically, in the case of a vertical (static) oven, grids made of or coated with any non-stick material, preferably silicone, and positioned on special trays will be used. Preferably, said trays will have at least one hole, of dimensions comprised between 0.2 cm×0.2 cm and 60 cm×60 cm, preferably 1 cm×1 cm, adapted to allow the passage of air through the same tray for the homogeneous cooking of foods. Said trays will be rectangular or square in size between 45 cm×30 cm and 120 cm×80 cm, preferably 60 cm×60 cm. Advantageously, again to encourage the homogeneous cooking of the portions of cut fruit and vegetables, the grids will have a mesh of between 0.2 cm×0.2 cm and 2 cm×2 cm, preferably 0.5 cm×0.5 cm. In the case of a horizontal (continuous) oven, the positioning of the portions of fruit and vegetable products to be dehydrated will take place on a belt made of a plurality of perforated modules of thermoplastic material, heat resistant, suitable for food use and easily washable;
cooking, after placement in said oven, vertical (static) or horizontal (continuous), at a temperature between 20° C. and 45° C., preferably between 25° C. and 40° C. for a time interval of 24 hours and 48 hours. The cooking temperature and the times of this processing step are advantageously calibrated to prevent the product from reaching a temperature of more than 40° C. Advantageously, said oven has a dehumidification system and a gas burner (LPG), always with the aim of minimizing the oxidative sources for the food being processed. Advantageously, for a uniform cooking on all the surfaces of the fruit and vegetable products, the oven is provided, both on a first end and on a second end, with air discharge and suction means. In more detail, during cooking, the air is alternatively dehumidified on one side and suctioned containing the moisture of the product on the other side and vice versa alternately with a duration of preferably 15 minutes. More specifically, the oven used in the process, also included in the scope of protection of the present patent, is preferably a closed air cycle. In fact, it is advantageously provided with an oxygen extractor and/or a nitrogen/carbon dioxide generator, which allow cooking of the fruit and vegetables substantially in the absence of oxygen, without however affecting the air outside the oven, in order to keep it breathable by the operators present in the laboratory. Advantageously, said oven, in the version in which it operates with a closed air cycle, is provided with heat recovery means to allow energy saving by the gas burner. After drying, the method continues with a step of
first packing, after removing from the oven, by means of common machines suitable for packaging a predetermined amount of said fruit and vegetable products in special sealed opaque bags filled with nitrogen for food use;
a possible second packing step in which a predetermined quantity of said fruit and vegetable products is taken from said opaque bags and packed into “Flow Pack” or any other desired package;
storing in special dark warehouses whose internal environment is at a temperature comprised between 15° C. and 22° C., and humidity comprised between 40% and 65%.

Advantageously, all the steps take place in a cool environment, substantially free of UV and dry rays, preferably at a temperature between 15° C. and 22° C., and humidity between 40% and 65%.

In a further, even more advantageous embodiment of the present invention, the energy and/or hot and dehumidified air necessary for the operation of the oven, with all its components just listed, comes from renewable sources such as, for example, photovoltaic systems, solar, thermal systems, etc.

The advantages offered by the present invention are clear in the light of the above description and will be even clearer from the accompanying figures and the related detailed description.

### DESCRIPTION OF THE FIGURES

The invention will hereinafter be described in at least one preferred embodiment thereof by way of non-limiting example with the aid of the accompanying figures, in which:

FIG. 1 shows the flowchart that underlies the method object of the invention, in its most articulated form.

FIG. 2 schematically shows a vertical oven 60, used in the cooking step 116, in which the trays 50 are arranged with the grids 51 superimposed thereon. The first end 61 and the second end 62 of the oven 60 are also indicated (which are at the top and bottom for illustrative but non-limiting purposes) from which the dehumidified air is suctioned and the air containing the moisture of the product is discharged.

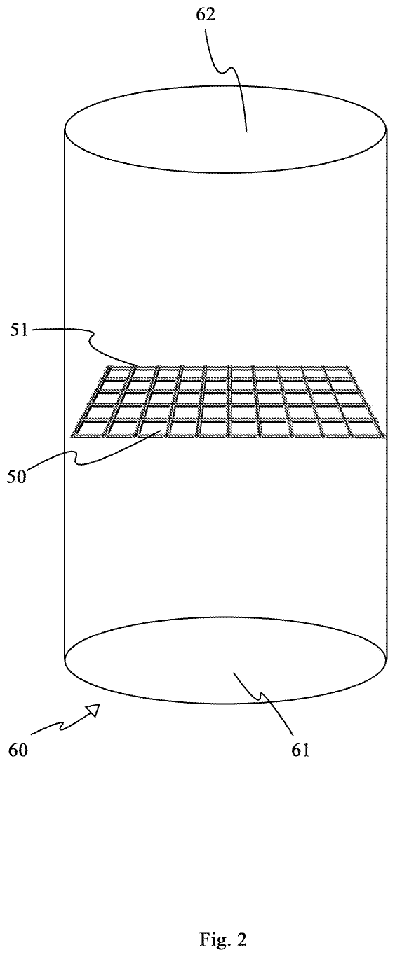

### DETAILED DESCRIPTION OF THE INVENTION

The present invention will now be described purely by way of non-limiting or binding example with the aid of the figures, which illustrate some embodiments relative to the present inventive concept.

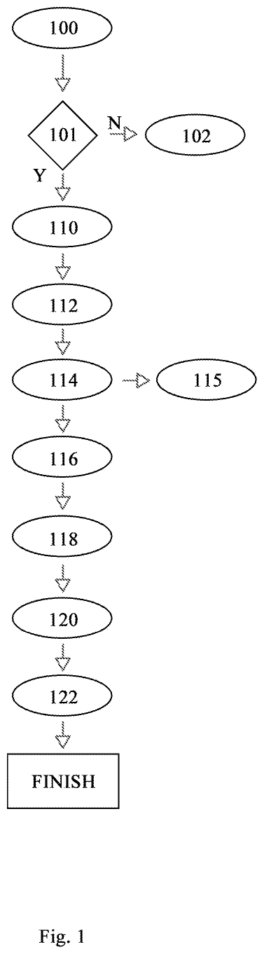

With reference to FIG. 1, it shows the diagram of the various steps of the method object of the invention, in its most complete form.

After receiving the products to be processed in laboratory 100, a verification step 101 of their biological/biodynamic certification follows. Based on the outcome of the verification 101, the method can continue with the rejection 102 of the products whose verification 101 gave negative result N and with the reception 100 of other products, or, in the case of positive result Y, with washing 110, peeling 112 and cutting 114 of fruit and vegetables. This washing step 110 occurs with filtered drinking water.

Washing 110, peeling 112 and cutting 114 can be done either by hand or by special machinery, depending on the convenience and size and type of fruit and vegetables to be dehydrated.

In a preferred embodiment, the method object of the invention is dedicated to the dehydration and packaging of kiwifruit, both green, yellow and red, cut into slices. More in detail, the green kiwi is cut into slices 3 mm thick, whereas the yellow and red kiwi is 5 mm, due to the lower resistance to breakage.

After these steps, a recycling step 115 of the portions of kiwi, or other food, which results from peeling 112 and from cutting 114 follows. These waste parts are reused in other industrial processes such as, for example, those aimed at producing dehydrated fruit bases for snack bars.

In the cutting step 114, the knives used have ceramic blades or are coated with a ceramic material or any other non-metallic material, which could promote the oxidation of food.

At this point, the kiwi slices (or other cuts of other products) are placed on grids or on a conveyor belt according to the type of oven 60 which will be used in the subsequent cooking step 116. In the case of vertical oven 60, also called “static”, the slices are placed on special perforated trays 50 to facilitate the passage of dehumidified air, of dimensions 60 cm×60 cm, on which there are grids 51 of mesh 0.5 cm×0.5 cm, in non-stick food silicone material. In the case of a horizontal oven 60, also called “continuous”, the slices are laid on the various modules of a conveyor belt which passes through the internal space of said oven 60. These modules are made of thermoplastic material, suitable for food use, easily washable and provided with holes that allow the passage of dehumidified air for a homogeneous cooking of food.

The cooking step 116 in oven 60 is carried out at a temperature between 25° C. and 40° C., for a period of time ranging from 24 hours to 48 hours, with attention given to the fact that the temperature of the foodstuffs during the whole cooking step, does not exceed 40° C. The oven 60 is the most important technological equipment involved in the method object of the invention. Due to its features and also to the other precautions taken at the industrial plant where this method takes place, the nutritive and organoleptic features and flavor of the fruit and vegetables thus processed remain substantially unchanged, like the fresh product.

Said oven 60 has a dehumidification system and a gas burner (LPG), which heats the air to promote the dehydration of the food without oxidizing it. The oven 60 used in the subject method also comprises discharge and suctioning means located both at a first end 61 and at a second end 62. At 15 minute intervals, the air discharged (dehumidified) from the first end 61 of the furnace 60 and suctioned (containing the moisture of the product) by the second end 62 changes towards and is discharged from the second end 62 and suctioned by the first end 61.

In its preferred embodiment, the oven 60 which allows the carrying out of the present invention is a closed air cycle so as to dehydrate the food in an environment free of oxygen and light and, at the same time, maintain a sufficient quantity of oxygen outside to keep the laboratory a livable environment for the operators. Said oven 60 is provided with at least one oxygen extractor and/or at least one nitrogen/carbon dioxide generator which creates a protective atmosphere, free of oxygen, inside the oven 60 itself.

Optionally, the oven 60 is also provided with means which recover the heat and reuse it to favor the least energy consumption of the burner.

Once the pre-set time has elapsed for the complete drying of the kiwi slices, these are extracted from the oven 60 and placed immediately, by a special packaging machine, in a sealed package, filled with food nitrogen.

Said packaging will preferably be white, or in any case opaque, to prevent the contact with the sunlight from deteriorating the food.

The method, in the preferred embodiment and considered the best, up to now, comprises a further possible second packing step 120 in which a predetermined quantity of said fruit and vegetable products is taken from said opaque bags and packed into “Flow Pack” or any other desired package.

The last step of the method, i.e. storage 122, takes place in relatively dry, cool and dark rooms, which contribute to the preservation of dehydrated foods. Preferably, the storage warehouses will be at a temperature between 15° C. and 22° C., and humidity between 40% and 65%.

Finally, it is clear that modifications, additions or variants may be made to the invention described thus far which are obvious to a man skilled in the art, without departing from the scope of protection that is provided by the appended claims.

1. Antioxidative method for cold dehydration and packaging of fruit and vegetable products comprising:
receiving the fruit and vegetable products in the laboratory (100) and the step (101) of verifying their organic certification; in case of negative result (N) of the verification (101) the method providing for a step (102) of disposing said products; in case of positive result (Y) of said verification (101) said method proceeding to the step of
manual or automatic washing (110), by means of special machines, using filtered potable water;
manual or automatic peeling (112), by means of special machines, depending on the dimensions of the fruit and vegetable products being processed;
cutting (114), by means of special automated machines, into pre-established shapes, depending on the type of fruit and vegetable products being processed;
cooking (116); said cooking step (116) being carried out after positioning the cut portions on special grills (51), if the oven (60) used for said cooking step (116) is vertical, or on the modules of a conveyor belt which passes through the oven (60), if said oven (60) is horizontal; said grills (51) being made of any anti-stick material or coated with said material, and positioned on special trays (50) perforated so as to allow the through-flow of air; said modules of said conveyor belt being made of any perforated thermoplastic polymer, suitable for handling foodstuffs and easily washable, whose holes are suitably dimensioned to enable a homogeneous cooking of the fruit and vegetable products portions; said cooking (116) being carried out in said oven (60) at a temperature comprised between 20° C. and 45° C., for an interval comprised between 24 hours and 48 hours;
first packing (118), after removing from the oven (60), by means of common machines suitable for packaging a predetermined amount of said fruit and vegetable products in special sealed opaque bags filled with nitrogen for food use;
storing (122) in special dark warehouses whose internal environment is at a temperature comprised between 15° C. and 22° C., and humidity comprised between 40% and 65%.

2. The antioxidative method for cold dehydration and packaging of fruit and vegetable products, according to claim 1, further comprising, after said peeling (112) and cutting (114) steps, a step (115) for recycling the waste parts of the fruit and vegetable products for re-utilisation in other production processes.

3. The antioxidative method for cold dehydration and packaging of fruit and vegetable products, according to claim 1, further comprising, after said first packing step (118), a further second packing step (120) in which a predetermined amount of said fruit and vegetable products is collected from said opaque bags and packed in another type of packaging.

4. The antioxidative method for cold dehydration and packaging of fruit and vegetable products, according to claim 1, wherein in said cutting step (114), the blades used for cutting the fruit and vegetable products are made of ceramic or coated with ceramic.

5. The antioxidative method for cold dehydration and packaging of fruit and vegetable products, according to claim 1, wherein said trays (50) are rectangular or square-shaped with dimensions comprised between 45 cm×30 cm and 120 cm×80 cm, and wherein said grills (51) have meshes comprised between 0.2 cm×0.2 cm and 2 cm×2 cm.

6. Oven (60) for cold dehydration of fruit and vegetable products, suitable for carrying out a cooking step (116) of the method described in claim 1, said oven (60) being provided with a de-humidification system and at least one gas burner; said oven (60) comprising timed air emission and suctioning means, arranged at a first end (61) and at a second end (62) of said oven (60), said emission and suctioning means being suitable to enable the fact that a predetermined amount of dehumidified air is emitted by the first end (61) and suctioned moist by the second end (62) and subsequently emitted dehumidified by the second end (62) and suctioned moist by the first end (61), in alternating steps with pre-established duration.

7. The oven (60) for cold dehydration of fruit and vegetable products, according to claim 6, wherein the oven is of the closed air cycle type.

8. The oven (60) for cold dehydration of fruit and vegetable products, according to claim 6, further comprising heat recovery means suitable to re-utilise the heat generated by said gas burner.

9. The oven (60) for cold dehydration of fruit and vegetable products, according to claim 6, wherein the oven is provided with at least one oxygen remover and/or at least one nitrogen/carbon dioxide generator, suitable to create a protective oxygen-free atmosphere solely regarding the interior space of said oven (60), enabling the antioxidative cooking (116) of said fruit and vegetable products, maintaining the air outside said oven (60) intact.

10. Fruit and vegetable products cold-dehydrated by means of the oven and method (60) according to claim 1, wherein the fruit and vegetable products have nutritional and organoleptic properties substantially equal to an equivalent fresh product.

11. The method of claim 1, wherein the material of which the grills are composed or coated is silicone.

12. The method of claim 11, wherein the cooking (116) is carried out in said oven (60) at a temperature comprised between 25° C. and 40° C.

13. The method of claim 5, wherein said trays (50) are rectangular or square-shaped with dimensions of 60 cm×60 cm, and wherein said grills (51) have meshes of 0.5 cm×0.5 cm.

14. The oven of claim 6, wherein the alternating steps have a pre-established duration of 15 minutes.

15. The antioxidative method for cold dehydration and packaging of fruit and vegetable products, according to claim 2, further comprising, after said first packing step (118), a further second packing step (120) in which a predetermined amount of said fruit and vegetable products is collected from said opaque bags and packed in another type of packaging.

16. The antioxidative method for cold dehydration and packaging of fruit and vegetable products, according to claim 2, wherein in said cutting step (114), the blades used for cutting the fruit and vegetable products are made of ceramic or coated with ceramic.

17. The antioxidative method for cold dehydration and packaging of fruit and vegetable products, according to claim 3, wherein in said cutting step (114), the blades used for cutting the fruit and vegetable products are made of ceramic or coated with ceramic.

18. The antioxidative method for cold dehydration and packaging of fruit and vegetable products, according to claim 2, wherein said trays (50) are rectangular or square-shaped with dimensions comprised between 45 cm×30 cm and 120 cm×80 cm, and wherein said grills (51) have meshes comprised between 0.2 cm×0.2 cm and 2 cm×2 cm.

19. The antioxidative method for cold dehydration and packaging of fruit and vegetable products, according to claim 3, wherein said trays (50) are rectangular or square-shaped with dimensions comprised between 45 cm×30 cm and 120 cm×80 cm, and wherein said grills (51) have meshes comprised between 0.2 cm×0.2 cm and 2 cm×2 cm.

20. The antioxidative method for cold dehydration and packaging of fruit and vegetable products, according to claim 4, wherein said trays (50) are rectangular or square-shaped with dimensions comprised between 45 cm×30 cm and 120 cm×80 cm, and wherein said grills (51) have meshes comprised between 0.2 cm×0.2 cm and 2 cm×2 cm.
